(19) United States
(12) Patent Application Publication
(10) Pub. No.: US 2026/0262146 A1
(43) Pub. Date: Sep. 3, 2026

(54) LIGHT-EMITTING PIXELS, FABRICS, AND RELATED COMPONENTS, PRODUCTS, AND METHODS

(71) Applicant: Purdue Research Foundation, West Lafayette, IN (US)

(72) Inventors: Chi Hwan Lee, West Lafayette, IN (US); Seungse Cho, West Lafayette, IN (US)

(21) Appl. No.: 19/368,091

(22) Filed: Oct. 24, 2025

Related U.S. Application Data
(60) Provisional application No. 63/712,289, filed on Oct. 25, 2024.

(51) Int. Cl. H05B 33/14; A63B 71/10; D03D 15/533; H05B 33/10; H05B 33/20; H05B 33/28

(52) U.S. Cl. CPC H05B 33/145; A63B 71/10; D03D 15/533; H05B 33/10; H05B 33/20; H05B 33/28

(57) ABSTRACT

Light-emitting pixels and methods of making and using light-emitting pixels in a fabric. Such a light-emitting pixel includes an electroluminescent thread having a conductive thread and an electroluminescent coating on a surface of the conductive thread, and a transparent conductive thread having an electrically-conductive surface. The electroluminescent coating contains an electroluminescent material. The electroluminescent thread and the transparent conductive thread contact each other to define the light-emitting pixel that generates light when a voltage is applied between the electroluminescent thread and the transparent conductive thread.

### CROSS-REFERENCE TO RELATED APPLICATIONS

This application claims the benefit of provisional U.S. Patent Application No. 63/712,289 filed October 25, 2024, the contents of which are incorporated herein by reference.

### BACKGROUND OF THE INVENTION

The present invention generally relates to textiles and methods for their manufacture. The invention particularly relates to light-emitting pixels, fabrics incorporating such light-emitting pixels, and components, products, and methods related thereto.

Light-emitting textiles are gaining increased attention due to their ability to create dynamic and interactive lighting effects, making them suitable for a variety of applications including wearable fashions, healthcare, and displays. Traditionally, light-emitting diodes (LEDs) and other types of light sources, such as electroluminescent (EL) thin films, have been glued or deposited directly onto textiles to produce garments of interest. However, these approaches can detrimentally affect fabric properties such as flexibility, wearability, and washability, and often require difficult conditions, such as high temperatures or vacuum, to be successful.

More recently, threads formed of EL materials and capable of being woven or knitted (instead of glued or deposited) into textiles have been developed, facilitating the integration of light-emitting textiles on a larger scale, with the ability to incorporate a vast array of lighting lines or pixels into textiles of up to several meters. Nevertheless, the arrangement of these EL threads has been restricted to either straight lines or rectangular patterns because they are interwoven with conductive fibers in both the warp and weft directions.

Embroidery, which involves stitching strands of threads across a fabric surface, offers a unique ability to create a wide range of decorative designs, from simple to intricate, on a wide variety of both woven and non-woven fabrics, making it a craft that is difficult to replicate by knitting or weaving. Machine embroidery produces a higher quality stitch and is faster, more precise, and less expensive compared to hand embroidery, thereby facilitating large scale applications. However, current EL threads are challenged to meet the strict requirements of machine embroidery, such as having a high tensile strength of at least 6 N, a moderate elongation at breakpoint below 100%, and a smooth surface finish.

In view of the above, there remains a need for materials and methods capable of producing light-emitting textiles and other fabrics that are capable of use in various applications, in which light-emitting elements can be incorporated into a textile or other fabrics while having minimal adverse impacts on the properties of the textiles.

### BRIEF SUMMARY OF THE INVENTION

The intent of this section of the specification is to briefly indicate the nature and substance of the invention, as opposed to an exhaustive statement of all subject matter and aspects of the invention. Therefore, while this section identifies subject matter recited in the claims, additional subject matter and aspects relating to the invention are set forth in other sections of the specification, particularly the detailed description, as well as any drawings.

The present invention provides, but is not limited to, light-emitting pixels, fabrics incorporating such light-emitting pixels, methods of making and using such light-emitting pixels in fabrics, wearable protective device incorporating such light-emitting pixels, and electroluminescent threads.

According to a nonlimiting aspect of the invention, a light-emitting pixel includes an electroluminescent thread having a conductive thread and a coating on a surface of the conductive thread, the coating including an electroluminescent material, and a transparent conductive thread having an electrically-conductive surface. The electroluminescent thread and the transparent conductive thread contact each other to define the light-emitting pixel that generates light when a voltage is applied between the electroluminescent thread and the transparent conductive thread.

According to another nonlimiting aspect of the invention, a fabric includes a plurality of the light-emitting pixels described above. The light-emitting pixels are incorporated into the fabric to define an array of the light-emitting pixels on the fabric.

According to another nonlimiting aspect of the invention, a method of producing a fabric with a light-emitting pixel as described above includes performing a machine embroidery process to incorporate the electroluminescent thread and the transparent conductive thread into the fabric so that the electroluminescent thread and the transparent conductive thread contact each other to define the light-emitting pixel.

According to another nonlimiting aspect of the invention, a method of using a light-emitting pixel as described above includes applying a voltage between the electroluminescent thread and the transparent conductive thread to generate light.

According to another nonlimiting aspect of the invention, a wearable protective device includes at least one of the light-emitting pixels described above. The wearable protective device may include a piece of wearable protective gear and an array of the light-emitting pixels incorporated into fabric of the wearable protective gear. An accelerometer may be coupled to the piece of wearable protective gear and configured to sense the level of force of an impact on the piece of wearable protective gear. A controller may be configured to energize a number of the light-emitting pixels corresponding to a level of force of the impact.

According to another nonlimiting aspect of the invention, an electroluminescent thread includes an electrically conductive thread and a coating including an electroluminescent material on a surface of the conductive thread.

Technical aspects of light-emitting pixels and methods as described above preferably include the ability to produce light-emitting textiles that are capable of use in various applications, in which light-emitting elements can be incorporated into a textile while having minimal adverse impacts on the properties of the textiles.

Other aspects and advantages will be appreciated from the following detailed description as well as any drawings.

### BRIEF DESCRIPTION OF THE DRAWINGS

FIG. 1A schematically illustrates components and a process of producing electroluminescent (EL) threads.

FIG. 1B schematically illustrates the use of an EL thread and a transparent conductive fiber (TCF) thread in a machine embroidery process to produce a light-emitting textile in accordance with a nonlimiting aspect of this invention.

FIG. 1C schematically represents a light-emitting pixel formed at the contact between a pair of EL and TCF threads in accordance with a nonlimiting aspect of this invention.

FIG. 1D shows a TCF thread at a light-emitting pixel encapsulated with an encapsulation layer in accordance with some nonlimiting aspects of the invention.

FIGS. 1E, 1F, and 1G are photographs of arrays of light-emitting pixels produced by the machine embroidery process of FIG. 1B.

FIG. 2A contains photographs and SEM images of EL threads in accordance with some nonlimiting aspects of the invention.

FIG. 2B contains top-view (top row) and cross-sectional view (bottom row) SEM images of EL threads formed with EL coatings having thicknesses of approximately 60µm, 90µm, 145µm, and 200µm, respectively, in accordance with some nonlimiting aspects of the invention.

FIG. 3 contains an SEM image (left) and an enlarged SEM image (right) of a TCF thread evidencing an Ag NWs network on the surface of the TCF thread in accordance with some nonlimiting aspects of the invention.

FIGS. 4A through 4F are graphs representing physical and optical characterizations of EL threads in accordance with some nonlimiting aspects of the invention. FIG. 4A plots the shear rate dependence of the viscosity of ZnS phosphor/TPU slurries used to produce EL coatings on EL threads. FIG. 4B plots the weight ratio dependence of thread diameter with respect to ZnS phosphors and TPU (error bars represent standard deviation, n = 3 for each group). FIG. 4C plots load-strain curve comparisons of a plain thread and an EL thread with different weight ratios of ZnS phosphors and TPU. FIG. 4D plots a surface roughness comparison of a plain thread and an EL thread with different weight ratios of ZnS phosphors and TPU. FIG. 4E plots the weight ratio dependence of EL intensity of the EL threads with respect to ZnS phosphors and TPU (error bars represent standard deviation, n = 3 for each group). FIG. 4F plots the luminance distribution around the circumference of an EL thread (error bars represent standard deviation, n = 3 for each group).

FIG. 5A represents the overall structure of a light-emitting pixel formed at the contact between an EL thread and a TCF thread, and FIGS. 5B through 5E characterize aspects of light-emitting pixels formed by EL and TCF threads in accordance with some nonlimiting aspects of the invention. FIG. 5A contains a schematic representation (left image), a side-view photograph (center image), and top-view photographs (right image) of a light-emitting pixel created at the contact between an EL thread and a TCF thread. FIG. 5B contains photographs of light-emitting pixels at various stitch distances and angles. FIG. 5C is a graph plotting the relative EL intensity of a light-emitting pixel in relation to the stitch distance and angle between the EL thread and TCF thread (error bars represent standard deviation, n = 3 for each group). FIG. 5D is a graph plotting the relative EL intensity of a light-emitting pixel as a function of upper thread tension (error bars represent standard deviation, n = 3 for each group). FIG. 5E is a graph plotting the relative EL intensity of a light-emitting pixel under repetitive pressing and releasing cycles.

FIGS. 6A through 6I represent light emission characteristics of a light-emitting pixel in accordance with some nonlimiting aspects of the invention. FIG. 6A is a graph plotting the luminance variation of light-emitting pixels in response to applied voltages at different frequencies (circles) and corresponding fitting curves (lines). FIG. 6B is a graph plotting the current density of light-emitting pixels with respect to applied voltages at different frequencies. FIG. 6C is a graph plotting the power consumption of light-emitting pixels with respect to luminance at different frequencies. FIG. 6D contains photographs of light-emitting textiles under stretching, bending, and rolling. FIG. 6E is a graph plotting the relative EL intensity of light-emitting pixels during 10,000 stretching cycles at a tensile strain of 20% (error bars represent standard deviation, n = 3 for each group). FIG. 6F is a graph plotting the relative EL intensity of light-emitting pixels during 10,000 cycles of vertical, diagonal, and horizontal folding (error bars represent standard deviation, n = 3 for each group). FIG. 6G is a graph plotting the relative EL intensity of light-emitting pixels during multiple laundry cycles. Insets show photographs of the corresponding light-emitting textile (error bars represent standard deviation, n = 3 for each group). FIG. 6H is a graph plotting local temperature variations of light-emitting pixels relative to time (error bars represent standard deviation, n = 3 for each group). FIG. 6I contains thermal images of light-emitting pixels after continuous operation up to six hours.

FIG. 7A contains a schematic representation of a head impact monitoring system, which incorporates an integrated impact sensor and a 6 x 3 array of light-emitting pixels into a commercial helmet liner designed for compatibility with a football helmet in accordance with some nonlimiting aspects of the invention.

FIG. 7B contains photographs of the light-emitting pixels of FIG. 7A illuminated following an impact in either the x-direction (θ = 0°) or at an oblique angle (θ = 70°) with varying levels of impact severity (mild, moderate, and severe).

FIGS. 8A through 8C contain photographs of the light-emitting pixels of FIG. 7A illuminated after impact from (FIG. 8A) y-direction (θ = 90°), (FIG. 8B) oblique direction (θ = 45°), and (FIG. 8C) front oblique direction (θ = 20°) with corresponding impact severity.

### DETAILED DESCRIPTION OF THE INVENTION

The intended purpose of the following detailed description of the invention and the phraseology and terminology employed therein is to describe what is shown in the drawings, which include the depiction of and/or relate to one or more nonlimiting embodiments of the invention, and to describe certain but not all aspects of what is depicted in the drawings, including the embodiment(s) to which the drawings relate. The following detailed description also describes certain investigations relating to the embodiment(s) depicted in the drawings, and identifies certain but not all alternatives of the embodiment(s) depicted in the drawings. As nonlimiting examples, the invention encompasses additional or alternative embodiments in which one or more features or aspects shown and/or described as part of a particular embodiment could be eliminated, and also encompasses additional or alternative embodiments that combine two or more features or aspects shown and/or described as part of different embodiments. Therefore, the appended claims, and not the detailed description, are intended to particularly point out subject matter regarded to be aspects of the invention, including certain but not necessarily all of the aspects and alternatives described in the detailed description.

The following describes fabrics (textiles) into which electroluminescent (EL) threads can be incorporated, and describes EL threads that are compatible with standard embroidery machines and as such can be used to stitch various different types of patterns, including but not limited to functional articles and decorative designs, onto various fabrics without unduly compromising the wear resistance of the fabrics or the light-emitting capabilities of the EL threads. As nonlimiting examples, EL threads can be incorporated into various types of fabrics to create arrays of light-emitting pixels that can be used to produce illuminated messages or designs on consumer products or to provide indications of physical hazards, such as providing alerts on helmets worn in athletic and industrial settings. In the following discussion, the terms “textiles” and “fabrics” are used interchangeably to include any type of woven or non-woven fabric.

In investigations leading to the present invention, embroiderable multicolor EL threads were produced that were shown to be compatible with universal embroidery machines and capable of being incorporated into various consumer fabrics to form light-emitting pixels within the fabrics. The EL threads were durable against folding, stretching, and repetitive machine washes, while satisfying requirements for machine embroidery. In the investigations, a universal and programmable machine embroidery was employed to craft various patterns and designs of light-emitting pixels on a variety of consumer fabric items (e.g., cotton towels, flags, t-shirts, and rugs) across large areas of up to several tens of centimeters and at speeds exceeding 350 stitches per minute.

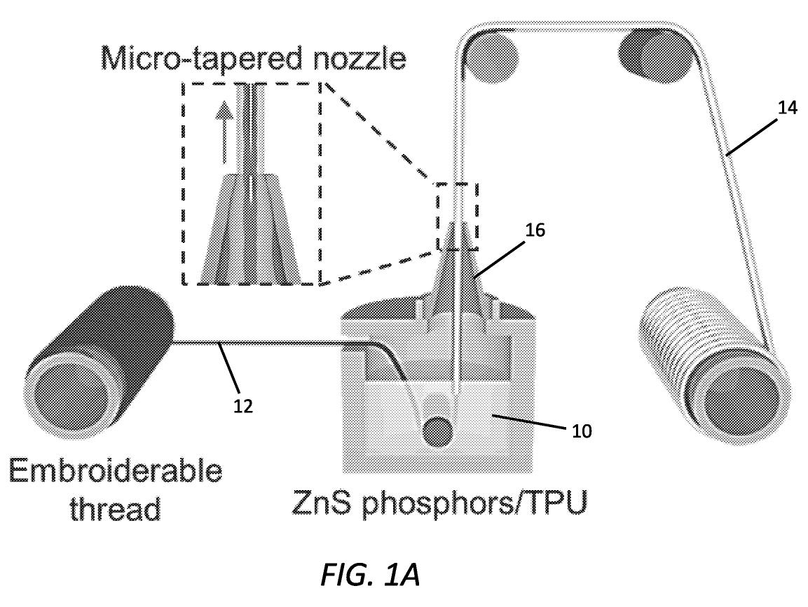

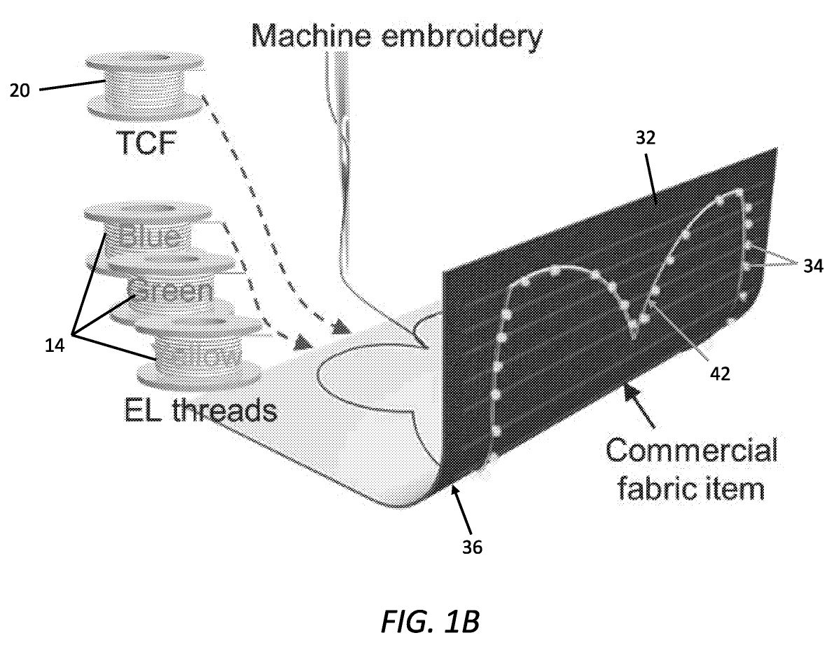

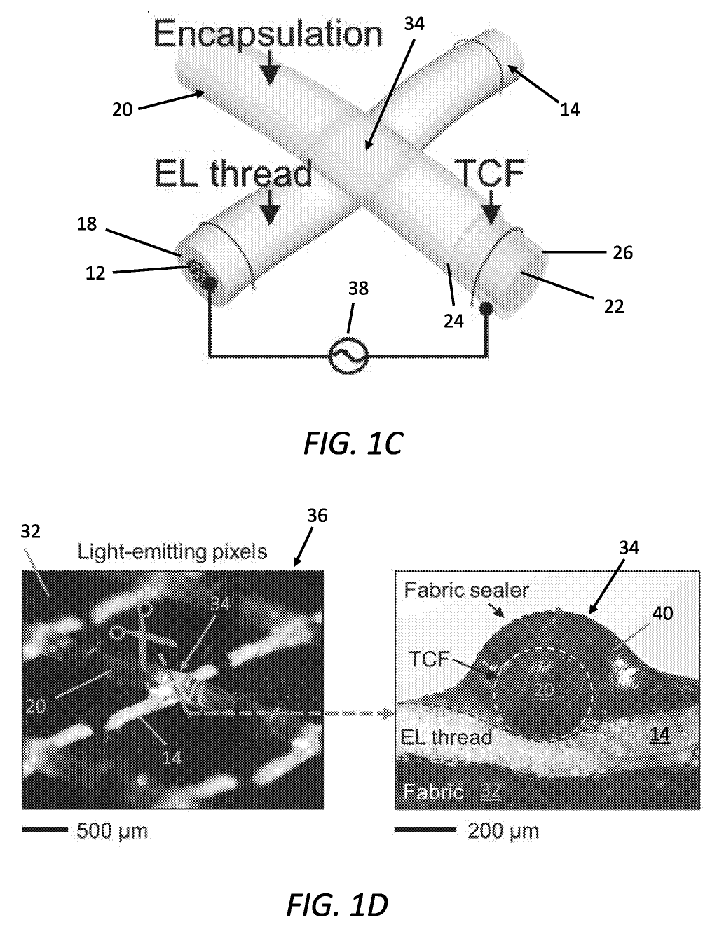

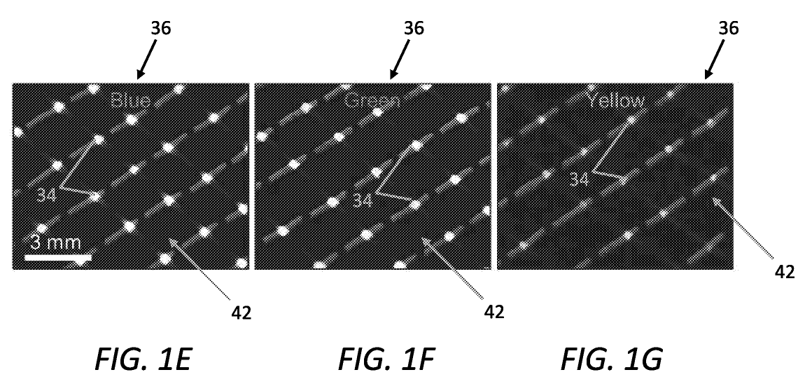

FIGS. 1A and 1B contain schematic diagrams of components and a process that includes the production of an embroiderable EL thread and the fabrication of an array of light-emitting pixels by machine embroidery into a fabric to yield a light-emitting textile. The process involves coating a layer of an EL material 10 onto the surface of an embroiderable electrically conductive thread 12 to produce what is referred to herein as an EL thread 14. In the nonlimiting examples evaluated during the investigations, the EL materials 10 were produced as mixtures of doped zinc sulfide (ZnS) phosphors and thermoplastic polyurethane (TPU). The EL materials 10 were deposited onto commercially-available silver-plated conductive threads 12 that had an electrical resistance of less than 0.9 Ω cm^{–1}. Though particular EL materials, polymers, and conductive threads were investigated, it should be apparent that other EL materials and thread materials could be substituted.

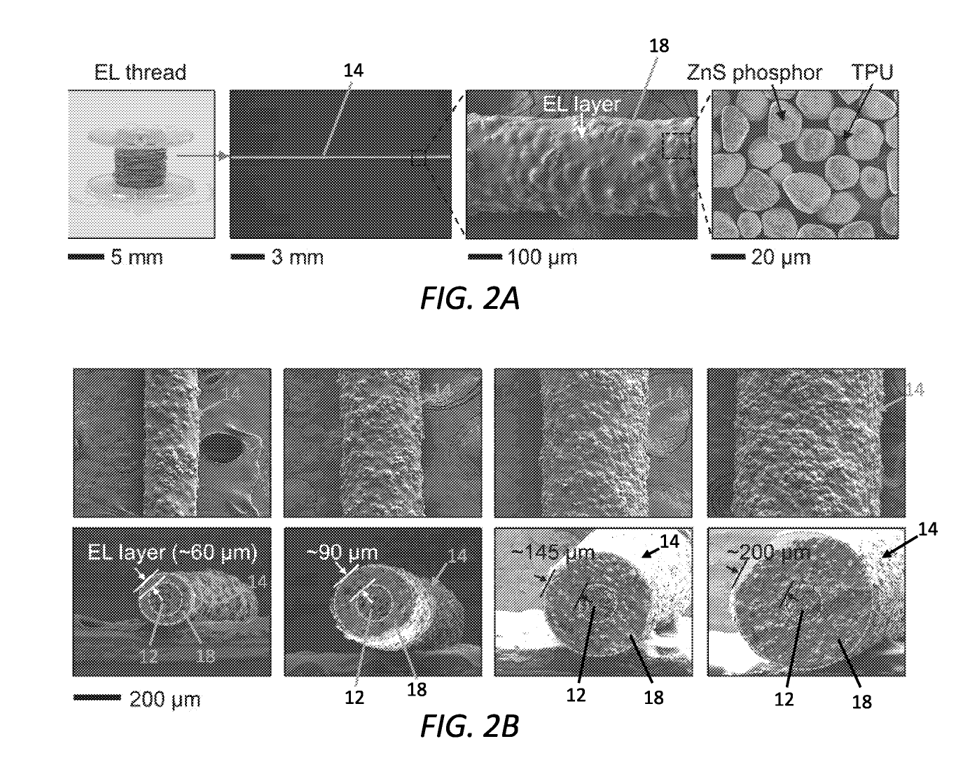

To fabricate the EL threads 14, a mixture of tetrahydrofuran and N, N'-dimethylformamide was used to dissolve TPU pellets. The resulting TPU solution was then mixed with doped ZnS phosphors (average diameter of approximately 20.6µm) in weight ratios ranging from 0.5:1 to 5:1 (ZnS phosphor to TPU). The resulting TPU/ZnS phosphor mixtures (EL material) 10 were applied onto the Ag-plated conductive threads 12 by passing the threads through a tapered nozzle 16 to deposit a layer of the TPU/ZnS phosphor mixtures onto the exterior surfaces of the threads 12. In the investigations, tapered nozzles 16 were utilized having different tip diameters of 250, 410, 580, and 840µm to deposit mixture layers of different thicknesses onto the threads. The mixture layers were partially dried in an air-dry oven at room temperature after each coating process, which were conducted three times on each thread to ensure a uniform thickness of the resulting coating 18 of EL material 10 on each EL thread 14. To remove residual solvents, the EL threads 14 were dried at 80 ℃ in an air-dry oven. The process described above uniformly applied the EL coatings 18 over the threads in both the longitudinal and circumferential directions of the threads, as can be seen in FIG. 2A. The thicknesses of the dried EL coatings 18 were in a range of about 60µm to about 200µm, examples of which can be seen in FIG. 2B.

The dopants utilized in the ZnS phosphors were selected to enable the EL threads 14 to generate light of different colors (wavelengths). In particular, the doped ZnS phosphors were copper and manganese whose type and amounts were chosen to produce blue, green, and yellow light as a result of containing about 0.1 wt.% copper, about 0.01 wt.% copper, and about 1 wt.% manganese, respectively. EL threads 14 adapted to generate different colors using different combinations of phosphors and dopants are foreseeable and within the scope of the invention.

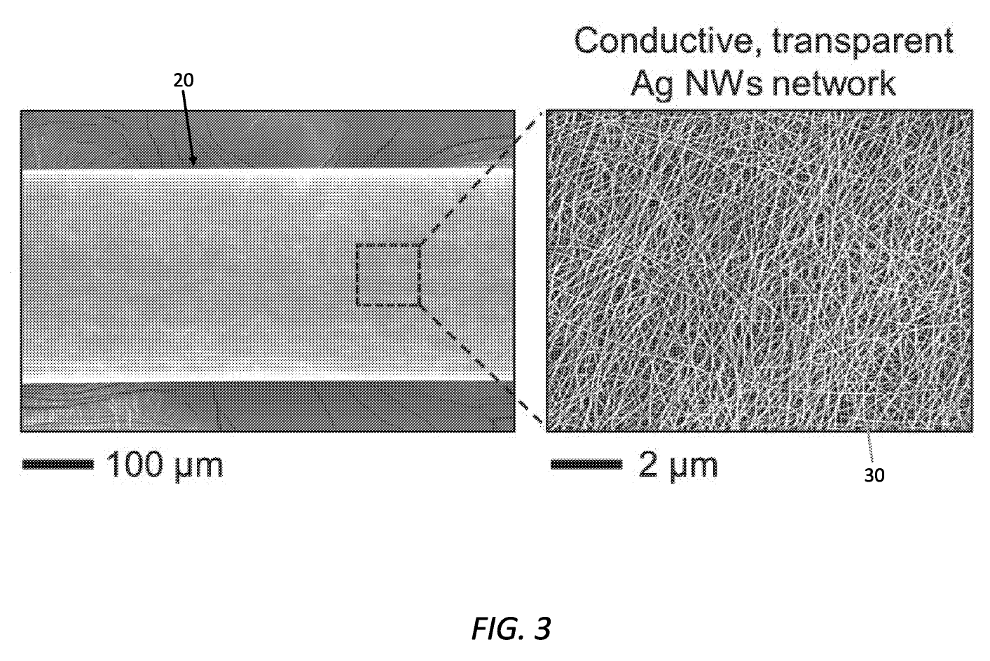

For the investigations, the EL threads 14 were used in combination with transparent conductive threads 20 to create light-emitting pixels. The transparent conductive threads, referred to herein as transparent conductive fiber (TCF) threads 20, were prepared by coating an embroiderable transparent nylon fiber 22 (300µm-thick) with silver (Ag) nanowires 24 (Ag NWs) using an adhesion promoter 26 containing a mixture of 90 wt.% ethyl acetate and 9 wt.% resorcinol. Ag NWs were chosen for their low electrical resistance, high optical transmittance, and mechanical flexibility. The Ag NWs 24 were uniformly coated across the surfaces of the nylon fiber 22, forming a conductive and transparent network 30 as seen in FIG. 3. The optical transparency and electrical resistance of the resulting TCF threads 20 were measured as 83.0 to 90.1% at 550nm and 73 to 35 Ω, respectively, with a relative deviation of less than 5%. A TCF thread 20 was evaluated by being subjected to greater than 10,000 cycles of bending at a radius of less than 1mm without notable signs of degradation, confirming the adhesion between the nylon fiber 22 and Ag NW network 30 adhered to its surface.

FIG. 1B depicts a machine embroidery process by which the EL threads 14 and the TCF threads 20 were incorporated into a fabric 32 to create light-emitting pixels 34 in the fabric, resulting in what may be referred to as a light-emitting textile 36. After stabilizing the fabric 32 and placing it on a stitch plate, the EL threads 14 and TCF threads 20 were continuously supplied from respective bobbins. In the investigations, the EL thread 14 was initially stitched onto the fabric 32 while adjusting the stitch distance and upper thread tension. Subsequently, the TCF thread 20 was stitched on the EL thread to form light-emitting pixels 34 at each intersection between the EL threads 14 and the TCF threads 20, one of which is schematically represented in FIG. 1C and shows the single light-emitting pixel 34 defined by an EL thread 14 and a TCF thread 20 stitched in an overlapped layout. An additional upper thread was then looped around the EL and TCF threads as they were stitched into a pattern that matched an intended design. The machine embroidery process was used to create different patterns (designs) of the light-emitting pixels 34.

FIG. 1C also represents an electrical connection of a power supply 38 to the EL threads 14 and TCF threads 20 for supplying an AC voltage to the pixels. Connections to the power supply 38 were established with the threads 14 and 20 using copper tape and Ag paste. To enhance mechanical durability, electrical insulation, and oxidation resistance (to promote washability), FIG. 1D contains images showing a thin layer (less than 120µm-thick) of a transparent and waterproof encapsulation layer (fabric sealant) that was applied as an encapsulation layer 40 onto the TCF threads to encapsulate the TCF threads and maintain contact between the EL and TCF threads. The encapsulation layer had a high optical transparency (greater than 95% at 550nm), such that the encapsulation layer was considered to have a minor effect on the EL intensity of a light-emitting pixel formed by the TCF thread and an EL thread.

FIGS. 1E, 1F, and 1G depict arrays 42 of blue, green, and yellow light-emitting pixels 34 when subjected to an AC voltage of 120V at a frequency of 2kHz. The chromaticity coordinates of the blue, green, and yellow lights produced by the light-emitting pixels 34 were, respectively, (0.17, 0.45), (0.16, 0.22), and (0.53, 0.42) with respect to the CIE 1931 standard color-matching. The relative deviations in emission intensity of the light-emitting pixels 34 in all tested colors varied by less than 10%, confirming the uniform formation of pixels through the machine embroidery. Light-emitting textiles 36 having different light-emitting decorative designs were produced during the investigation on various consumer goods, such as cotton towels, flags, T-shirts, and rugs. Intricate and curved designs were achieved by selectively illuminating the light-emitting pixels 34 arranged in a rectangular grid.

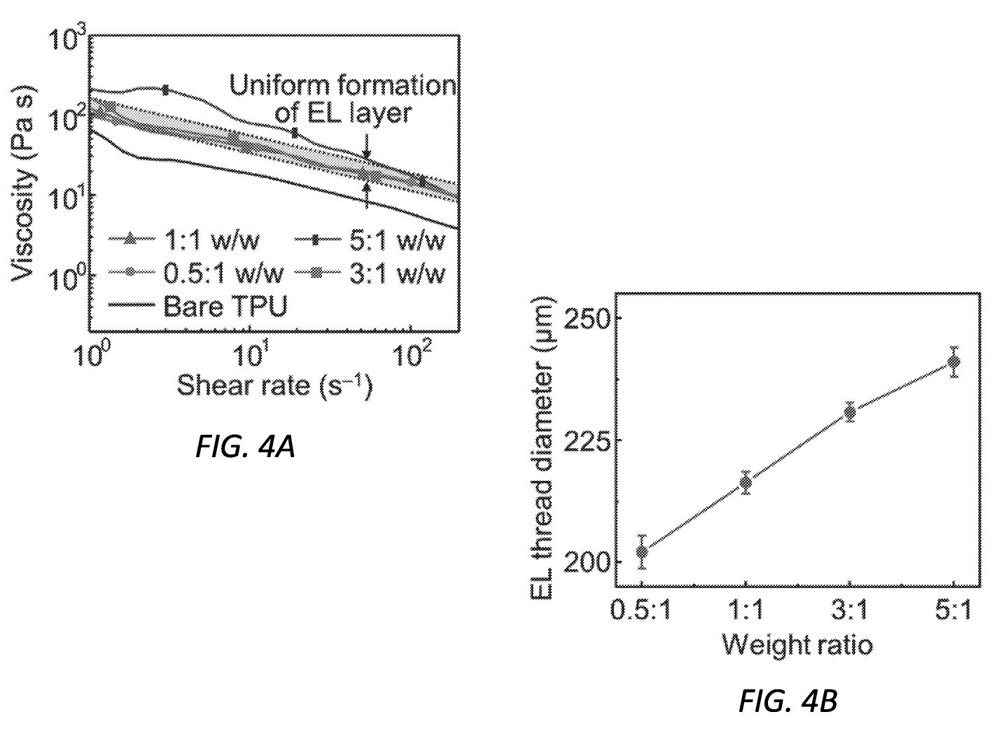

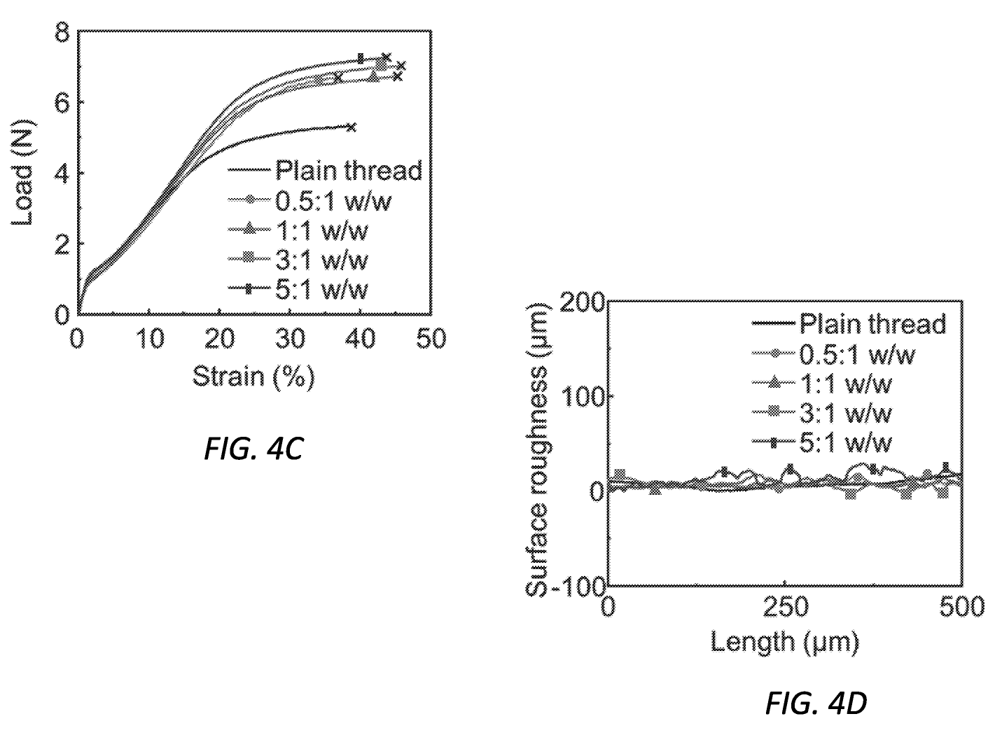

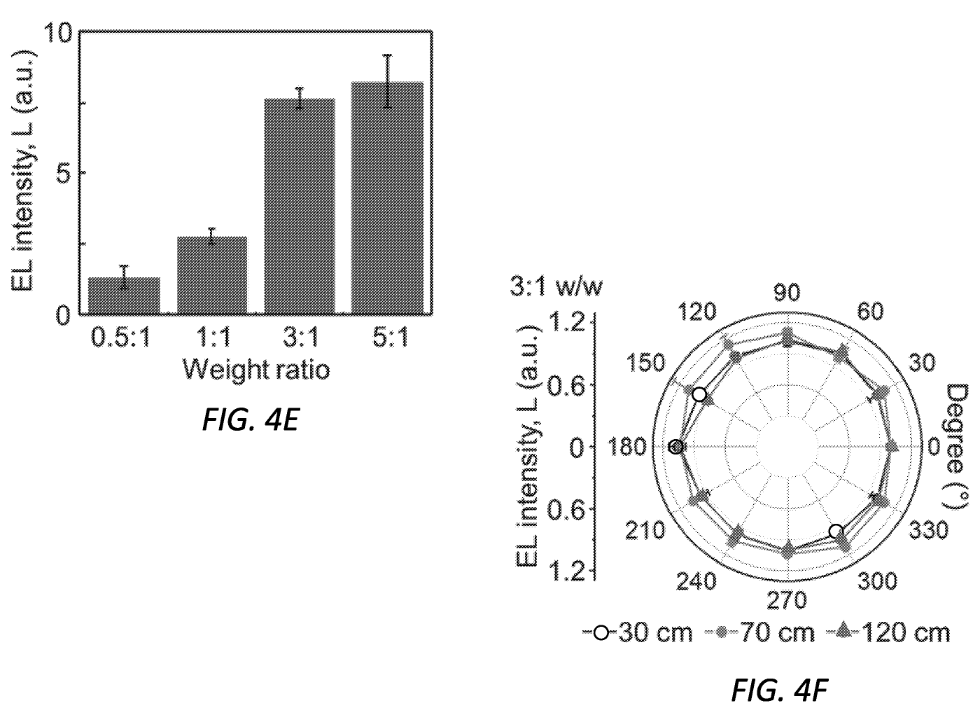

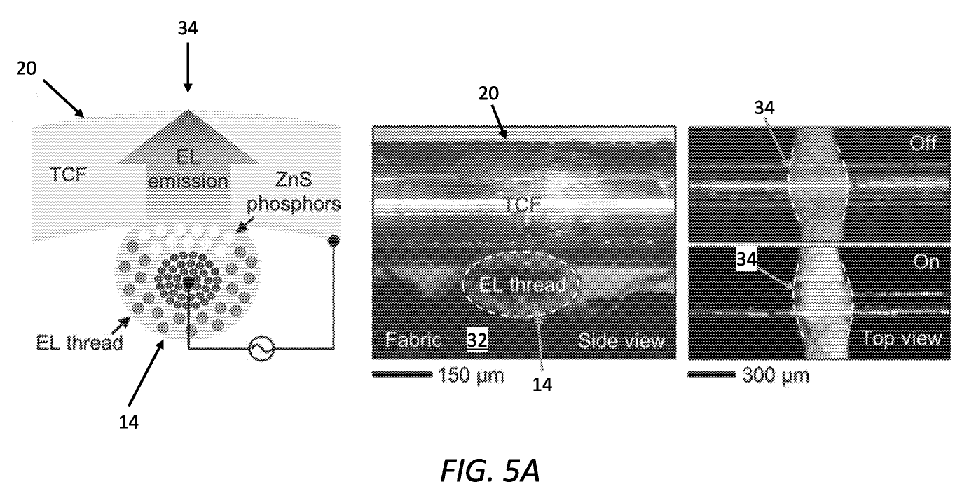

To be compatible with machine embroidery utilized at a commercial scale, the EL threads 14 preferably meet certain requirements, such as consistent coverage of the EL material 10 on the embroiderable EL thread, a tensile strength of greater than 6 N, moderate elongation at the breaking point of less than 100%, and a surface finish with minimal roughness to avoid stitching jams. The viscosity of EL materials 10 prepared using different weight ratios of ZnS phosphors and TPU was measured. The EL materials 10 exhibited the shear-thinning behavior in which their viscosity decreased with an increase of the shear rate. The highlighted region in FIG. 4A indicates the viscosity range that was found to produce highly uniform EL layers. When the weight ratio of ZnS phosphors exceeded 5:1 relative to the TPU, the EL materials became excessively thick, hindering their consistent production. FIG. 4B is a graph showing that the diameter of the EL layer increased in a range from about 200µm to about 240µm with respect to weight ratio increased.

FIG. 4C is a graph showing the tensile strength of the EL threads 14 as compared to that of a plain thread (without an EL layer). The EL threads 14 exhibited a superior tensile strength (σ = 6.7 to 7.3N) and a slightly lower elastic modulus (E = 17.7 to 21.5MPa), with a comparable range of elongation at break (ε < 45.6%), compared to a plain thread (σ = 5.7N, E = 22.7MPa, and ε = 38.5%). The improved properties of the EL threads 14 were attributed to the presence of the EL coatings 18, which were soft and pliant (E < 0.14 MPa). The plain thread, inherently multifilament in nature, exhibited a relaxed demeanor at rest. The introduction of the EL coating 18 acted as an adhesive agent, binding the individual fibers of the thread together, especially when subjected to tension. The substantial differences in elasticity and pliability between the two adjacent yet distinct materials were concluded to be the cause of a rise in tensile strength and a decline in elastic modulus, respectively.

FIG. 4D is a graph showing that the surface roughness of the EL threads was as smooth as that of a plain thread (R_{q} = 7.9 to 8.3µm), except for the EL threads with a 5:1 ZnS phosphor to TPU weight ratio (R_{q} = 15.4µm). The corresponding measurement data of these properties for the TCF thread 20 were σ = 51.8 to 54.1N, E = 90.2 to 90.7MPa, ε = 13.4 to 13.9%, and R_{q} = 1.9µm. FIG. 4E is a graph evidencing an increase in the luminance of the EL threads 14 with increasing weight ratio from 0.5:1 to 5:1 (ZnS phosphor to TPU), which reached a saturation at a 3:1 weight ratio of ZnS phosphor to TPU. The luminance intensity of the EL threads 14 was consistent both along the circumference (FIG. 4F) and in the axial direction. On the basis of these findings, the TCF threads 20 and the EL threads 14 with a 3:1 weight ratio of ZnS phosphor to TPU were both deemed to be well suited for use in machine embroidery.

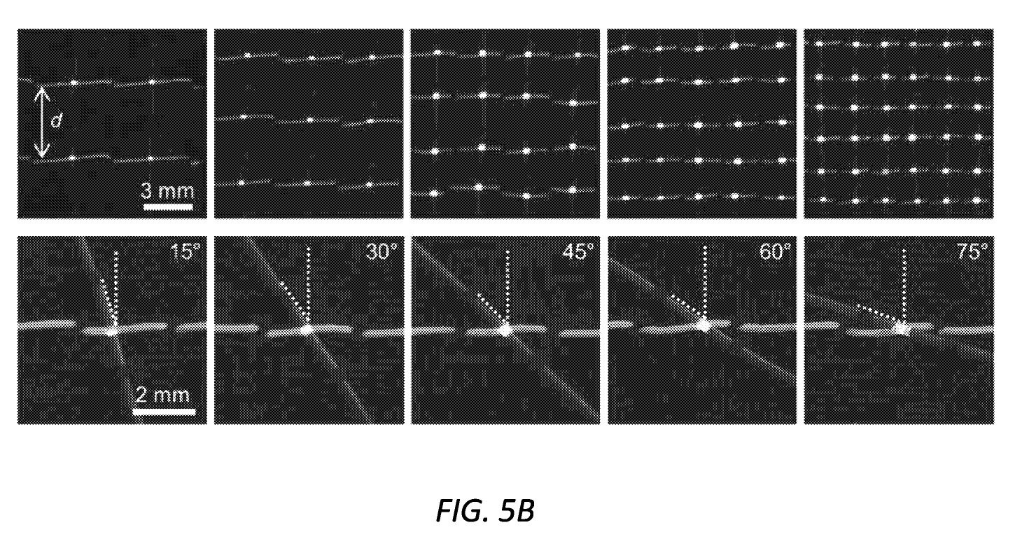

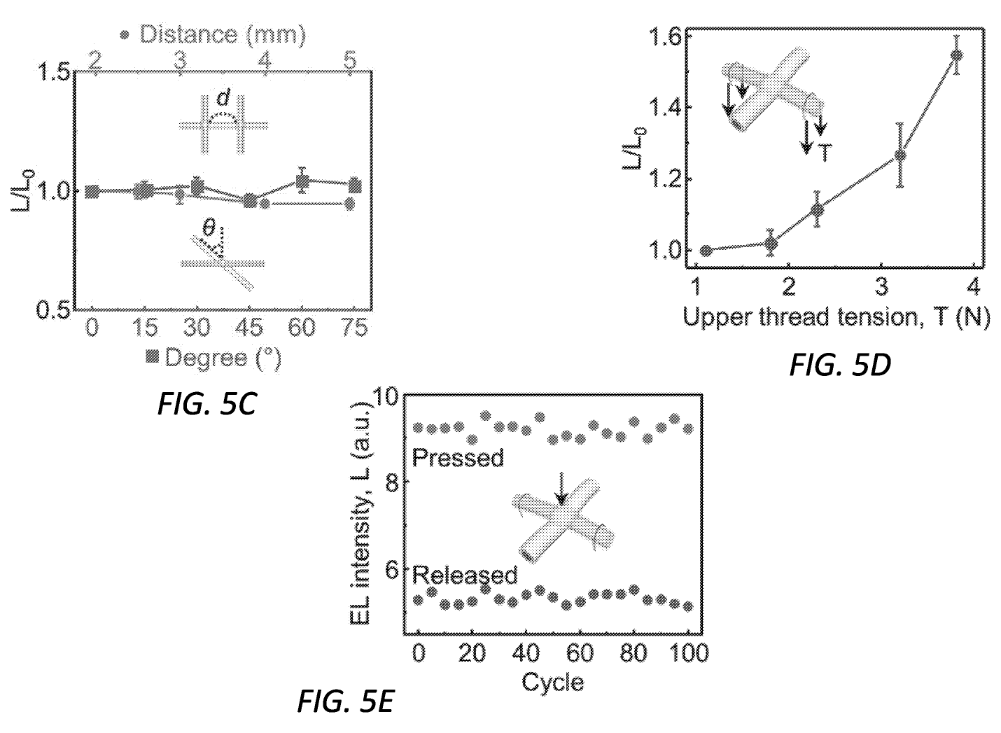

FIG. 5A presents a schematic illustration (left image) and a microscope image (center image) depicting side views of a light-emitting pixel 34, with an EL thread 14 portrayed at the bottom of the pixel and a TCF thread 20 portrayed at the top of the pixel so that the EL and TCF threads contact each other to form an intersection. The right images of FIG. 5A are top views of a pixel 34 with an AC voltage not applied (top image) and an AC voltage applied (bottom image) to the pixel so that the EL thread 14 emits light from a region thereof where the EL thread is contacted by the TCF thread 20. Injected hot carriers in the ZnS phosphors attain high speeds under the influence of an AC electric field and undergo impact ionization. This leads to the radiative relaxation of the luminescent center at a wavelength that corresponds to the dopants in the ZnS lattice, producing light emission at the intersection of the EL thread 14 and the TCF thread 20. Reliable light emission occurred at the intersection even when the EL thread 14 slid or rotated along the surface of the TCF thread 20.

FIG. 5B contains images of various arrays 42 of light-emitting pixels that were stitched into fabrics 32 at different densities, with a stitching distance ranging from 2 to 5mm (top row of images), and with different angles (θ) between the EL threads 14 and TCF threads 20, ranging from 15 to 75° (bottom row of images). The relative change in the EL intensity (L/L₀) of the light-emitting pixels remained constant across the fabrics (FIG. 5C). The L/L₀ of the light-emitting pixels increased exponentially by 54% as the upper thread tension increased from 1.1 N to 3.8N, due to the reduction in the thickness of the EL layer (FIG. 5D). This resulted in a stronger electrical field being applied to the ZnS phosphors. The EL intensity of the light-emitting pixels 34 remained nearly unchanged even after undergoing 100 cycles of pressing at 1.2MPa and releasing (FIG. 5E).

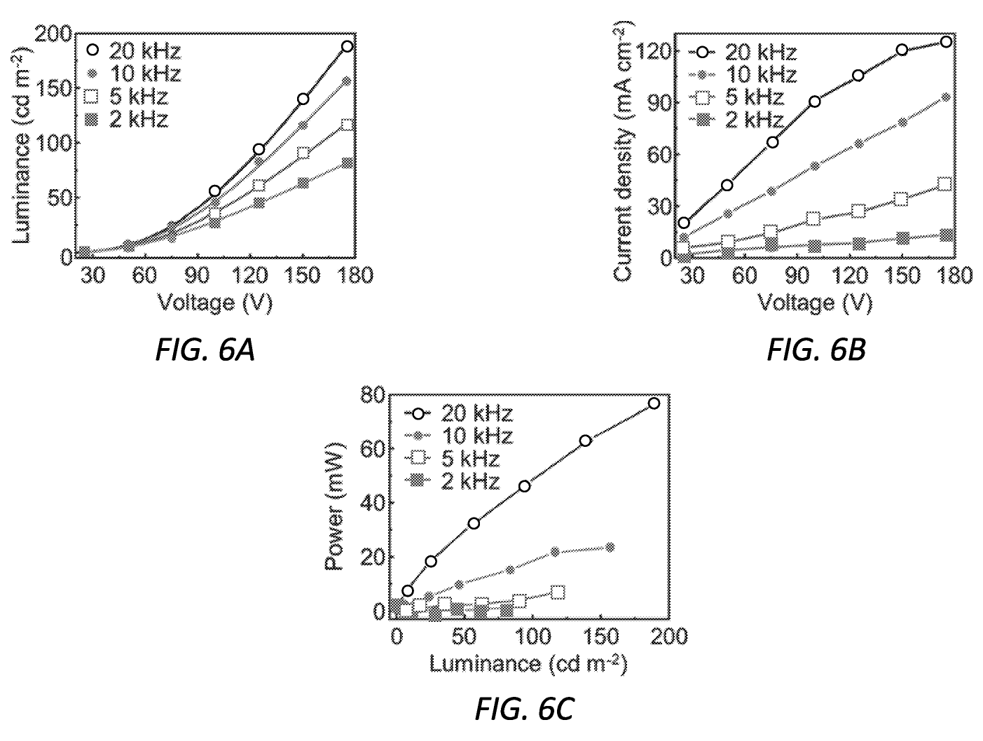

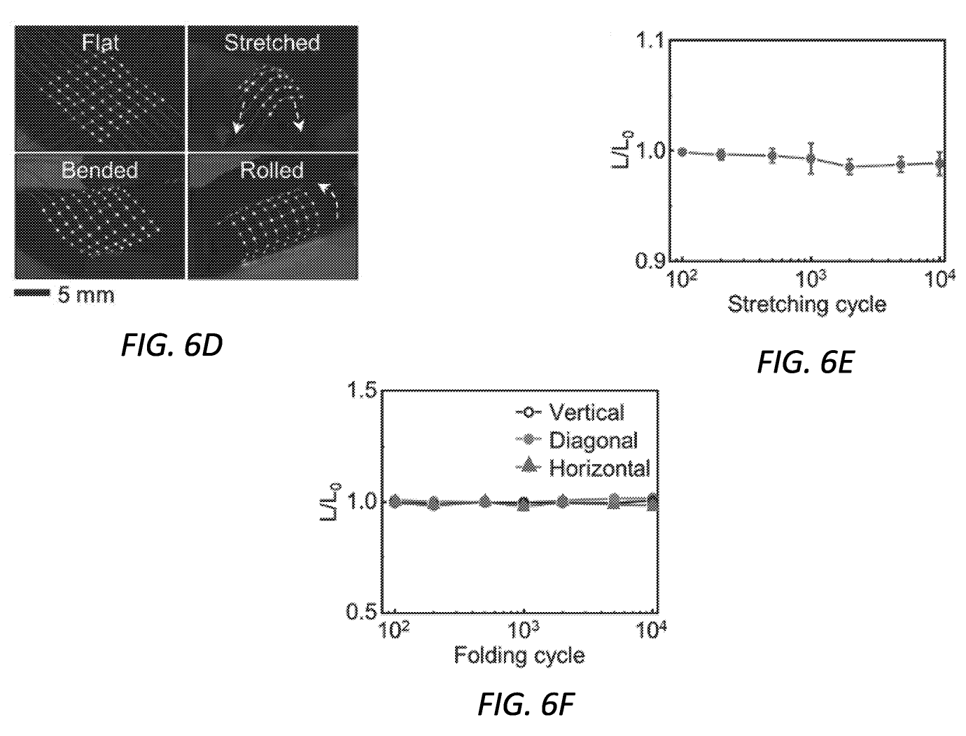

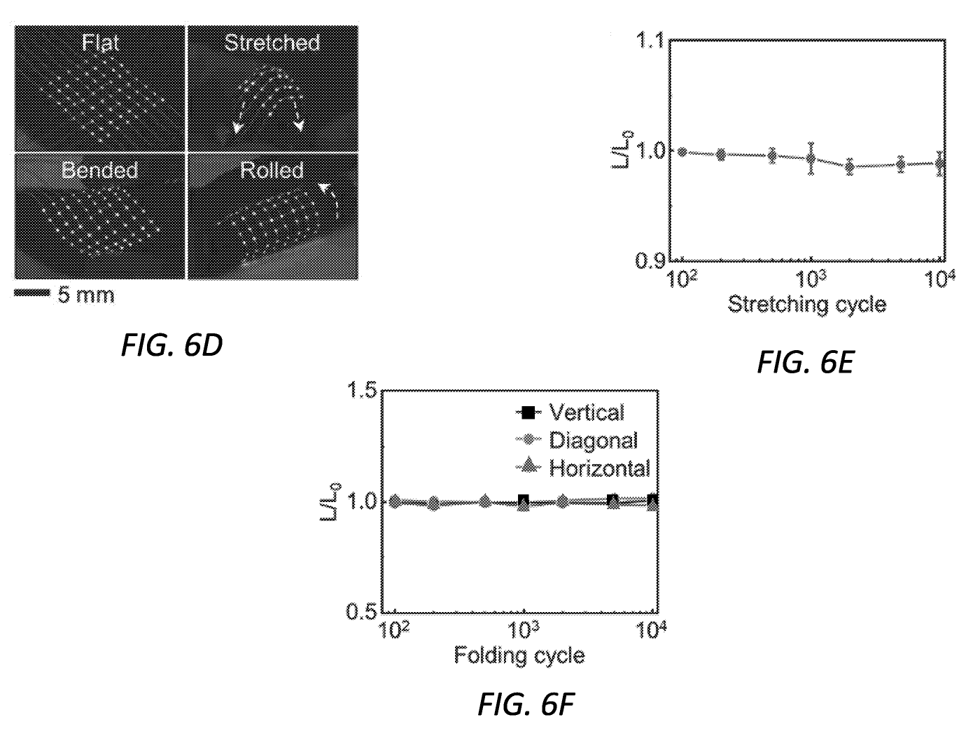

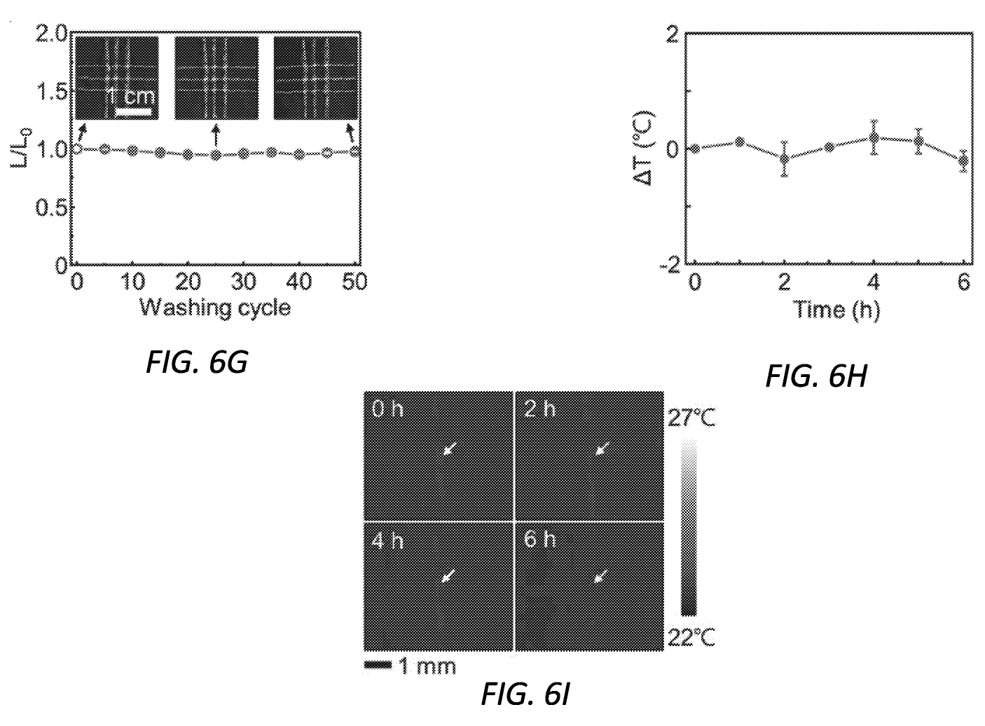

FIG. 6A illustrates the influence on the EL luminance of varying the AC voltage (ranging from 25 to 175V) and frequency (from 2 to 20kHz) applied to pixels. With an increase in frequency at a fixed voltage of 175V, the light emission intensity gradually increased, resulting in a luminance increase from 81.38 to 189.2cd m⁻². Above a certain threshold voltage, the probability of electrons being accelerated to excite luminescent centers surged rapidly, leading to a sharp escalation in EL intensity. The current density ranged from 13.6 to 125.1mA cm⁻² as the frequency varied from 2 to 20kHz at a voltage of 175V (FIG. 6B). The power consumption varied from 1.06 to 76.4mW as the luminance changed from 81.4 to 189.2cd m⁻² at frequencies ranging from 2 to 20kHz (FIG. 6C). The results confirmed low power consumption, which can be attributed to the alternating-field-induced emission mechanism that effectively avoids charge accumulation.

FIG. 6D shows an 8 × 8 array 42 of light-emitting pixels 34 that maintained stability even when bent, stretched, and rolled, without visible degradation in their emission performance. The L/L₀ of the light-emitting pixels remained under 1.5% and 1.8% even after undergoing repetitive cycles of stretching at 20% (FIG. 6E) and folding in vertical, diagonal, and horizontal directions (FIG. 6F), respectively. Minimal hysteresis was observed in the luminance during these loading-unloading cycles.

FIG. 6G demonstrates the effect of multiple laundry cycles (greater than 50 cycles) on the L/L₀ of the light-emitting pixels 34 using a standard household washing machine and a water-permeable protective sack. The light-emitting pixels 34 showed no noticeable damage when tested with the encapsulation layer (fabric sealant) 40 as shown in FIG. 1D. In contrast, light-emitting pixels 34 without the encapsulation layer 40 became non-functional after the first cycle of washing due to loosened contacts between the EL threads 14 and the TCF threads 20. Under ambient conditions, the L/L₀ of the light-emitting pixels 34 remained stable for over three months without any notable degradation in performance. However, without the presence of the encapsulation layer 40, the light-emitting pixels deteriorated over time and failed after 1.5 months due to the oxidation of the Ag NWs on the TCF thread surface, which resulted in loss of electrical conductivity. Furthermore, the light-emitting pixels 34 exhibited minimal temperature changes (less than 0.21 ℃) during continuous operation for over six hours at 150V and 20kHz (FIG. 6H), indicating their suitability for long-term and continuous use. Corresponding infrared (IR) images are shown in FIG. 6I.

To investigate the capabilities of a wearable functional article utilizing the light-emitting pixels 34 as described above, an array 42 of the light-emitting pixels 34 was embroidered onto a helmet liner 44 for use with a football helmet 46 equipped with an impact sensor 48. The intent was to assess the ability of the light-emitting pixels 34 to be utilized in a functional article configured to detect potential severe head impacts and alert the possibility of a concussion. Such a wearable article with a real-time warning system can be helpful for preventing and managing traumatic brain injury, particularly in collision sports. The array 42 of light-emitting pixels 34 may help provide early detection and treatment of potential head impacts or concussions, leading to improved outcomes and a reduced risk of further injury or complications. The combination of the helmet liner 44 and impact sensor 48 is just one nonlimiting example of a functional article and/or wearable article into which the light-emitting pixels 34 could be incorporated. The light-emitting pixels 34 may be incorporated into many other types of articles, and the examples provided herein are not intended to be limiting.

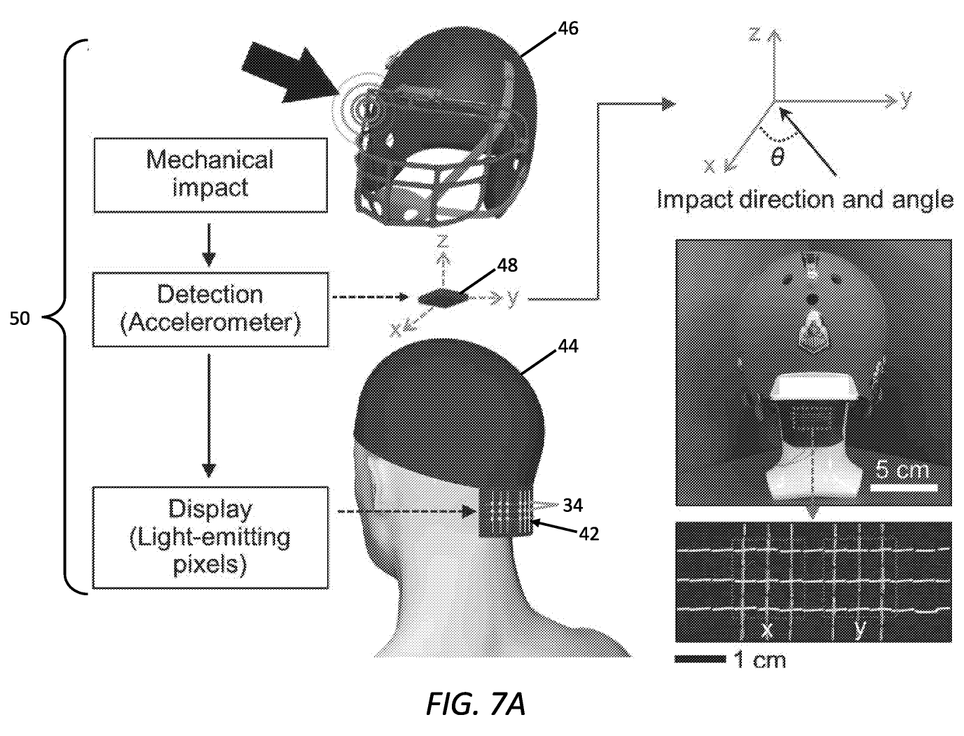

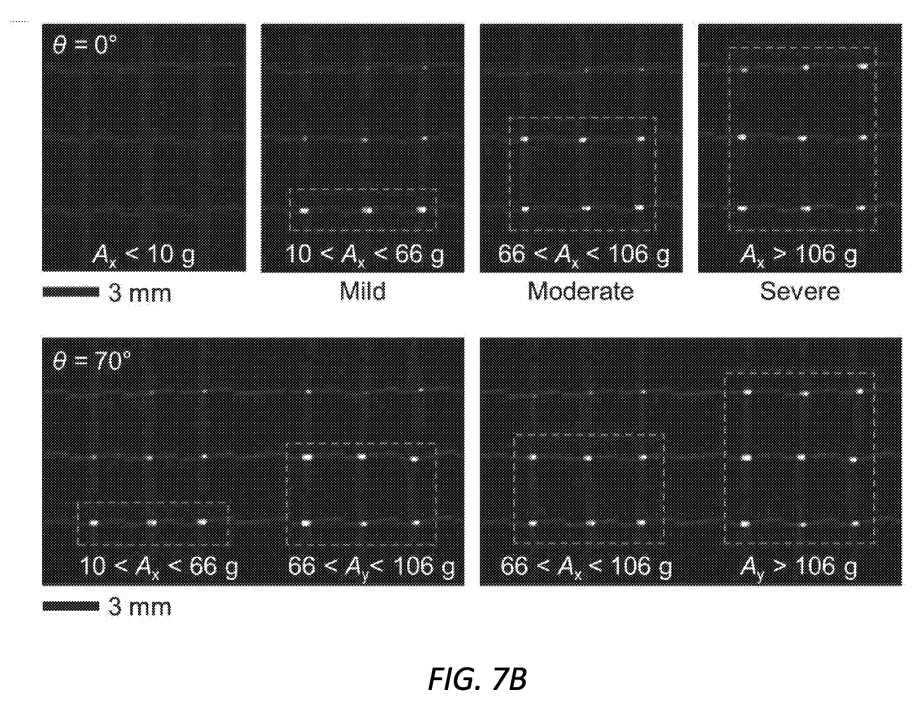

FIG. 7A schematically illustrates a visual impact meter 50 for a wearable protective device 46. In this example, the wearable protective device 46 is a football helmet, and the visual impact meter 50 for the football helmet 46 is equipped with an accelerometer 48 (scan rate = 1ms), microcontroller, relay, power supply, and a stretchable helmet liner 44; however, the visual impact meter 50 could be incorporated and configured into other types of wearable protective devices, such as pads, guards, protective vests, and other types of helmets. The liner 44 had a rear skull cap embroidered with the light-emitting pixels 34. The light-emitting pixels 34 were arranged in a 6 × 3 array 42 of six columns and 3 rows of pixels. An investigation was then conducted with the setup to assess the ability of the light-emitting pixels 34 to indicate the direction and severity of the impacts in real-time. The helmet 46 was placed on a mannequin head and mechanical impacts were applied to the helmet using a 30-pound (13.6kg) dumbbell at various angles and directions. The accelerometer 48 was positioned inside the helmet and connected to a microcontroller so as to measure the linear acceleration of the helmet upon impact. A second microcontroller was used to drive a relay module to supply a controlled voltage to the light-emitting pixels incorporated into the liner. The severity of each impact was sensed by the accelerometer and classified as mild (10 to 66g), or moderate (66 to 106g), or severe (greater than 106g). Whenever the linear acceleration value obtained from the accelerometer exceeded a predetermined threshold value for each impact severity, a voltage signal was generated by the microcontroller and sent to the relay, which turned on a corresponding column and row of the light-emitting pixels 34.

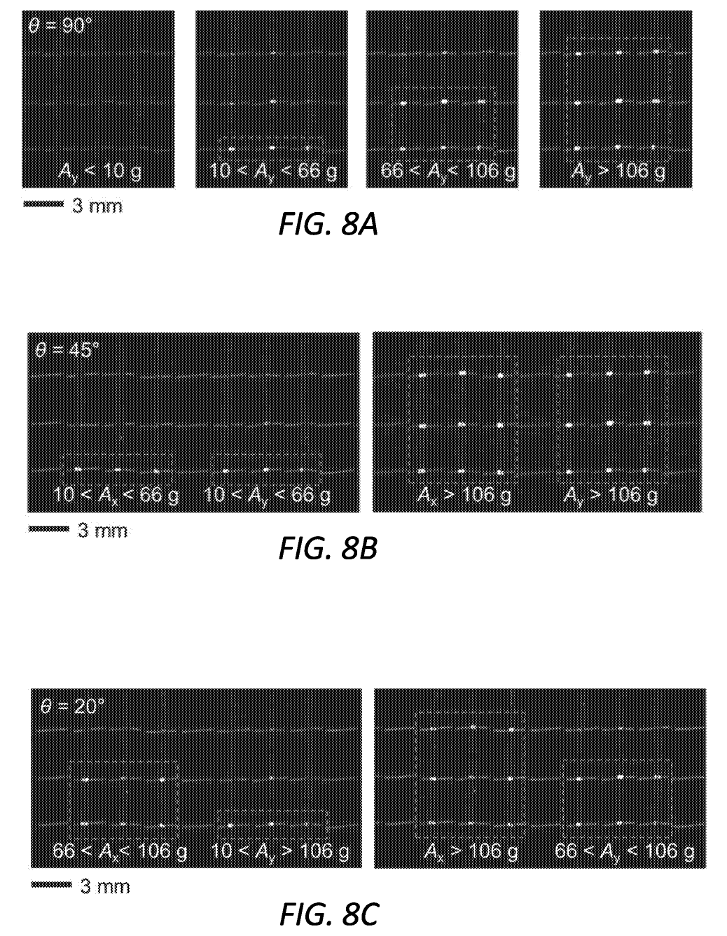

FIG. 7B demonstrates that, when the helmet 46 was impacted from the front (θ = 0°, only in the x-direction), the corresponding row of light-emitting pixels 34 in the x-column of the array were illuminated depending on the mechanical impact severity. When the helmet was impacted from the side oblique (θ = 70°), the corresponding row of light-emitting pixels 34 in both the x- and y-columns were illuminated simultaneously. The corresponding results when the helmet was impacted from the side (θ = 90°, only in the y-direction), oblique (θ = 45°), and front oblique (θ = 20°) are shown in FIGS. 8A through 8C, respectively. Thus, the investigation demonstrated the ability of using the light-emitting pixels to visualize mechanical impacts on a head in terms of direction, angle, and intensity, which could be valuable for early concussion management in sports or situations where close proximity is necessary in daily life.

The investigations described above evidenced a system and method by which the light-emitting pixels 34 can be incorporated into textiles using the EL threads 14 and the TCF threads 20 that are compatible with standard embroidery machines. Compared to traditional EL threads used for weaving or knitting, the evaluated EL and TCF threads were thinner and more durable, making them suitable for machine embroidery when crafting light-emitting textiles with various different patterns and designs. In addition, the EL threads 14 can be embroidered onto a wide range of consumer fabric items at high speed, while ensuring consistent luminescence (relative deviation of less than 10%), low power consumption (less than 76mW), durability (greater than 10,000 cycles of stretching and folding), and machine washability (greater than 50 laundry cycles). Their adjustable colors, luminescent intensities, and pixel positions provided greater versatility and creative potential, allowing them to meet the requirements of a wide range of applications. In light of the investigations, it was also concluded that the light-emitting pixels can be incorporated into textiles and utilized to display real-time information obtained from embedded sensors, and therefore a candidate for health-related applications that benefit from immediate and practical data visualization.

As previously noted above, though the foregoing detailed description describes certain aspects of one or more particular embodiments of the invention and investigations associated with the invention, alternatives could be adopted by one skilled in the art. For example, light-emitting pixels and patterns formed therewith could differ in appearance and construction from the embodiments described herein and shown in the drawings, functions of certain components could be performed by components of different construction but capable of a similar (though not necessarily equivalent) function, and process parameters could be modified, and appropriate materials could be substituted for those noted. As such, and again as was previously noted, it should be understood that the invention is not necessarily limited to any particular embodiment described herein or illustrated in the drawings.

1. A light-emitting pixel comprising:
an electroluminescent thread comprising a conductive thread and a coating on a surface of the conductive thread, the coating comprising an electroluminescent material; and
a transparent conductive thread having an electrically-conductive surface, the electroluminescent thread and the transparent conductive thread contacting each other to define the light-emitting pixel that generates light when a voltage is applied between the electroluminescent thread and the transparent conductive thread.

2. The light-emitting pixel of claim 1, wherein the electroluminescent material comprises a phosphor dispersed in a polymer.

3. The light-emitting pixel of claim 2, wherein the phosphor is a doped zinc sulfide.

4. The light-emitting pixel of claim 1, wherein the coating has a thickness of about 60 to about 200 micrometers.

5. The light-emitting pixel of claim 1, wherein the electrically-conductive surface of the transparent conductive thread is formed by silver nanowires.

6. The light-emitting pixel of claim 1, further comprising an encapsulation layer that encapsulates the transparent conductive thread and maintains contact between the electroluminescent thread and the electrically-conductive surface of the transparent conductive thread.

7. A fabric comprising a plurality of the light-emitting pixels of claim 1, wherein the plurality of the light-emitting pixels is incorporated into the fabric to define an array of the light-emitting pixels on the fabric.

8. The fabric of claim 7, wherein the array defines a light-emitting decorative design on the fabric.

9. The fabric of claim 7, wherein the array defines a light-emitting functional article on the fabric.

10. The fabric of claim 9, wherein the functional article comprises an impact sensor that delivers the voltage to the array of the light-emitting pixels to generate light when an impact is sensed by the impact sensor.

11. A method of producing a fabric with the light-emitting pixel of claim 1, the method comprising:
applying the coating to the surface of the conductive thread to form the electroluminescent thread;
forming the electrically-conductive surface of the transparent conductive thread; and
performing a machine embroidery process to incorporate the electroluminescent thread and the transparent conductive thread into the fabric so that the electroluminescent thread and the transparent conductive thread contact each other to define the light-emitting pixel.

12. The method of claim 11, wherein performing the machine embroidery process includes incorporating the electroluminescent thread and the transparent conductive thread into the fabric so that the light-emitting pixel is one of a plurality of the light-emitting pixel incorporated into the fabric to define an array of the light-emitting pixels on the fabric.

13. The method of claim 12, wherein the array defines a light-emitting decorative design on the fabric.

14. The method of claim 12, wherein the array defines a light-emitting functional article on the fabric.

15. A method of using the light-emitting pixel of claim 1, the method comprising applying a voltage between the electroluminescent thread and the transparent conductive thread to generate light.

16. The method of claim 15, wherein the electroluminescent thread and the transparent conductive thread form a plurality of the light-emitting pixel incorporated into the fabric to define an array of the light-emitting pixels on the fabric.

17. The method of claim 16, wherein the array defines a light-emitting decorative design on the fabric.

18. The method of claim 16, wherein the array defines a light-emitting functional article on the fabric.

19. The method of claim 18, wherein the functional article comprises an impact sensor and the method comprises delivering the voltage to the array of the light-emitting pixels to generate light when an impact is sensed by the impact sensor.

20. The method of claim 19, wherein the functional article is a component of a helmet.

21. A wearable protective device comprising:
a piece of wearable protective gear;
an array of the light-emitting pixels of claim 1 incorporated into fabric of the wearable protective gear;
an accelerometer coupled to the piece of wearable protective gear and configured to sense the level of force of an impact on the piece of wearable protective gear; and
a controller that energizes a number of the light-emitting pixels corresponding to a level of force of the impact.

22. The wearable protective device of claim 21, wherein the piece of wearable protective gear comprises a helmet.

23. The wearable protective device of claim 22, wherein the piece of wearable protective gear comprises a helmet liner, and the array of the light-emitting pixels is incorporated into the helmet liner.

24. The wearable protective device of claim 22, wherein the piece of wearable protective gear comprises a football helmet.

25. The wearable protective device of claim 21, wherein the controller energizes a number of the light-emitting pixels that is indicative of a direction of the impact.

26. An electroluminescent thread comprising:
an electrically conductive thread; and
a coating on a surface of the conductive thread, the coating comprising an electroluminescent material.

27. The electroluminescent thread of claim 26, wherein the electrically conductive thread comprises silver-plated conductive thread.

28. The electroluminescent thread of claim 26, wherein the electroluminescent material comprises a mixture of doped zinc sulfide (ZnS) phosphors and thermoplastic polyurethane.

29. The electroluminescent thread of claim 28, wherein the mixture of doped ZnS phosphors and thermoplastic polyurethane is in weight ratios ranging from 0.5:1 to 5:1 ZnS phosphor to thermoplastic polyurethane.

30. The electroluminescent thread of claim 28, wherein dopant in the doped ZnS phosphors comprises at least one of copper and manganese.
